(19) United States
(12) Patent Application Publication
(10) Pub. No.: US 2001/0046812 A1
(43) Pub. Date: Nov. 29, 2001

(54) CONNECTOR

(76) Inventors: MICHEL FONTENEAU, LE MANS (FR); JACKY THENAISIE, LE MANS (FR); MICHEL LENOIR, MONTFORT LE GESNOIS (FR); JAN PETER KAREL VAN KOETSEM, ZWIJINDRECHT (BE)

Correspondence Address: CLARENCE A GREEN, PERMAN & GREEN LLP, 425 POST ROAD, FAIRFIELD, CT, 06430

(21) Appl. No.: 09/339,490

(22) Filed: Jun. 24, 1999

(30) Foreign Application Priority Data
Jun. 30, 1998 (FR) FR 98/08497

(51) Int. Cl. H01R 13/648

(52) U.S. Cl. 439/625

(57) ABSTRACT

A connector for high frequency signals comprises a housing of insulating material and female contact elements received in the housing and regularly arranged in rows and columns at a fixed intermediate spacing. The housing has a front side with inlet openings providing access to the contact elements, a connection side for connection to a printed circuit board, a cable or the like, and a plurality of cavities extending between the front side and the connection side. Adjacent cavities are separated by inner walls extending in row and column direction each cavity accommodating at least one contact element. At least the inner walls of the cavities are metallized and the corresponding contact element is supported within the cavity by support elements of insulating.

The invention relates to a connector for high frequency signals, comprising a housing of insulating material and female contact elements received in said housing and regularly arranged in rows and columns at a fixed intermediate spacing, said housing having a front side with inlet openings providing access to the contact elements, a connection side for connection to a printed circuit board, a cable or the like, and a plurality of cavities extending between the front side and the connection side, adjacent cavities being separated by inner walls extending in row and column direction, each cavity accommodating at least one contact element.

Connectors of this type are known in various embodiments. In the prior art connectors a plurality of the contact elements are used as signal contact elements and the remaining part of the contact elements are used as ground contact elements, wherein the arrangement of signal and ground contact elements is such that the signal contact elements are more or less surrounded by ground contact elements. Such known connectors require a high number of ground connections, whereas only a restricted number of contact elements is available as signal contact elements,

EP-A-0 735 624 discloses a connector wherein it is attempted to overcome the problems of these known connectors by providing a connector of a very complex design. This connector can not be used in an interchangeable manner within existing connector families. Moreover, production costs are relatively high.

The invention aims to provide an improved connector of the above-mentioned type, wherein the density of signal contact elements is significantly increased and wherein the connector can be used within existing connector families.

To this end the connector according to the invention is characterized in that at least the inner walls of the cavities are metallized, and in that each contact element is supported within the corresponding cavity by support elements.

In this manner a connector is obtained, wherein all contact elements can be used as signal contact elements as each contact element is mounted within a cavity having a metallization on the inner wall which is used as outer conductor.

The invention will be further explained by reference to the drawings in which an embodiment of the connector of the invention is schematically shown.

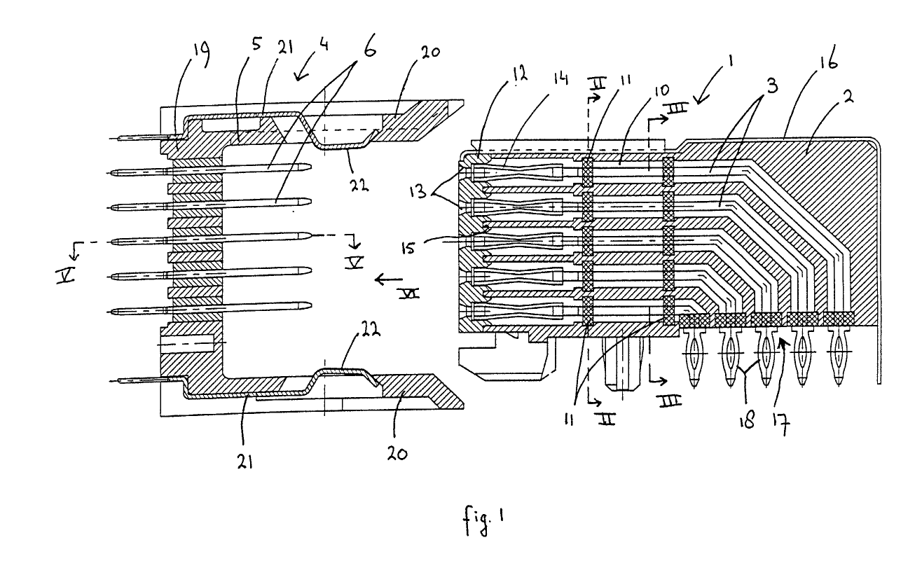

FIG. 1 schematically shows a cross section of a male type connector and a female type connector which can be inserted into the male type connector.

FIG. 2 shows a cross section of a part of the female type connector of FIG. 1 according to the line II-II.

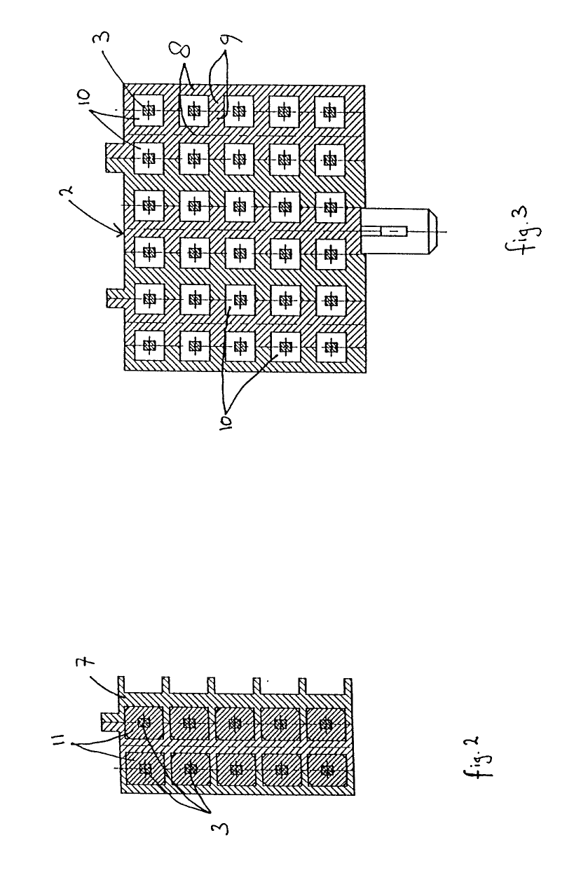

FIG. 3 shows a cross section of the female type connector of FIG. 1 according to the line III-III.

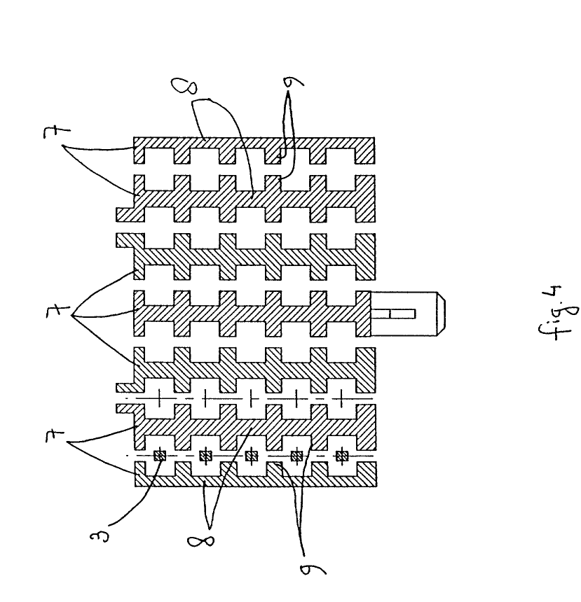

FIG. 4 shows the housing parts of the housing of the female type connector of FIG. 1 before assembly.

FIG. 5 is a cross section of the male type connector of FIG. 1 according to the line V-V.

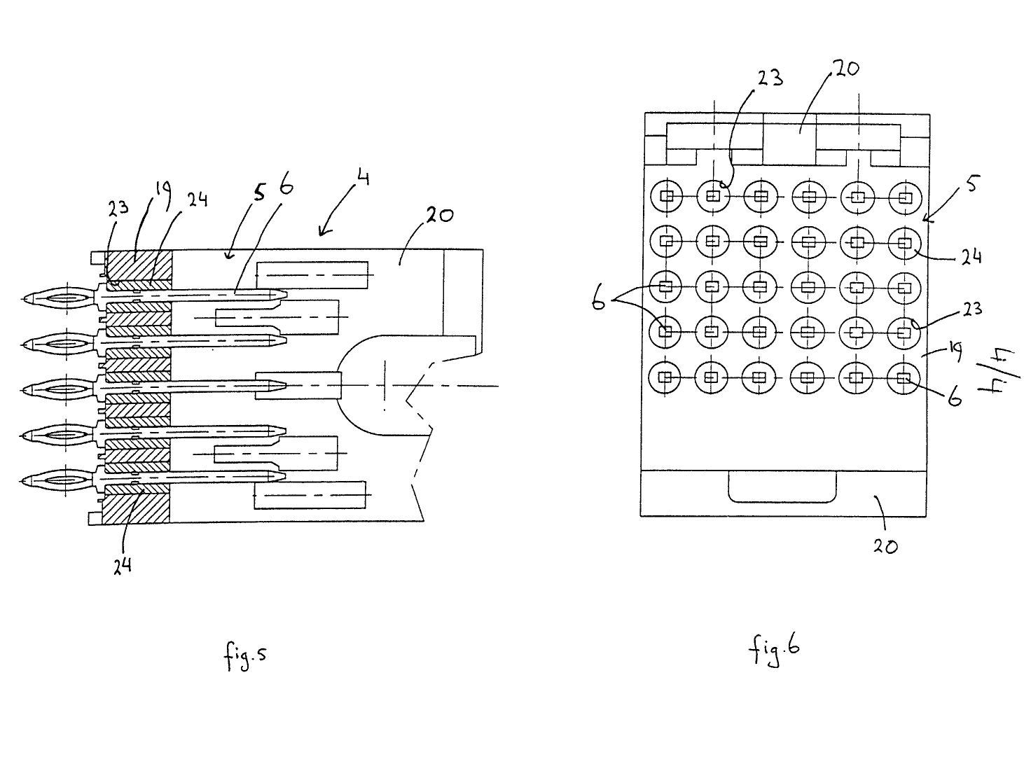

FIG. 6 shows a top view of the male type connector of FIG. 1 according to the arrow VI.

FIG. 1 shows in cross section a connector 1 for high frequency signals, comprising a housing 2 of insulating material and female contact elements 3 received in the housing 2. The female contact elements 3 are regularly arranged in rows and columns at a fixed intermediate spacing, wherein one column of contact elements 3 can be seen in the cross section of FIG. 1.

FIG. 1 further shows in cross section a connector 4 for high frequency signals, comprising a housing 5 of insulating material and male contact elements 6 received in the housing 5. The connector 1 can be inserted into the connector 4 to interconnect the female contact elements 3 and male contact elements 6. As in the connector 1, the male contact elements 6 are regularly arranged in rows and columns at a fixed intermediate spacing, wherein one column of male contact elements 6 can be seen in FIG. 1.

The housing 2 of the connector 1 is an assembly of a plurality of housing parts 7 shown in FIG. 4 before assembly. Each housing part is made of insulating material and is completely metallized. Each housing part 7 has a first wall 8 extending in column direction. At both sides of the first wall 8 second wall sections 9 extending in row direction perpendicular to the first wall 8 are provided, each two second wall sections 9 at both sides of the first wall 8 being aligned.

FIG. 3 shows a cross section of the connector 1 according to the line III-III, showing that the first wall 8 and second wall sections 9 provide inner walls of cavities 10. The female contact elements 3 are mounted within the cavities 10, each cavity 10 accommodating one contact element 3 in the embodiment shown. Of course it is also possible to provide cavities for accommodating two contact elements, for example in case of a twinax application. As the housing parts 7 are completely metallized, the inner walls of the cavities 10 are metallized too, so that the contact element 3 supported within the corresponding cavity 10 together with the metallization of the inner wall functions as a co-axial connector. Thereby a complete shielding of the contact element is obtained and the impedance of the contact element can be determined.

The contact elements 3 are supported within the cavities 10 by support elements 11 of insulating material. These support elements 11 are fixed on the contact elements 3 by overmoulding the support elements 11 on the contact elements 3. At the location of the support elements 11 the contact element 3 has a provision for anchoring the support element, for example a thickening or projection or the like.

At the front side of the connector 1 a front wall part 12 of insulating material is provided, wherein the front wall 12 has inlet openings 13 providing access to the contact elements 3. The contact elements 3 are provided with female spring-type contact parts 14, the front ends of which are received within holes provided in the front wall 12. Further the front wall 12 at the inner side is provided with slots 15, the front ends of the inner walls 8, 9 being received in said slots 15. Further, the housing 2 is provided with a shielding plate 16 enclosing the housing 2 at the upper side and left and right sides. The shielding plate 16 is connected to the metallization of the outer walls of the housing 2. In this manner a complete shielding of the connector 1 is guaranteed.

In the embodiment shown the connector 1 is provided with a connection side 17 enclosing an angle of 90° with the front side, wherein the cavities 10 extend between the front side and the connection side 17. At the connection side 17, the contact elements 3 project out of the housing 2 and in the embodiment shown these projecting ends are made as press-fit terminals 18 for connection to a printed circuit board not shown. It will be understood that the same type of connector can also designed with other types of terminals or as a cable connector or the like.

The connector 4 shown in FIG. 1 is further shown in FIG. 5 and 6. The housing 5 comprises a bottom 19 and two side walls 20 extending in row direction. On the outer side of the side walls 20 shielding plates 21 are provided having contact ends 22 for contacting the shielding of the connector 1. The bottom 19 is provided with cavities 23 arranged in rows and columns. The inner walls of the cavities are metallized and each male contact element 6 is supported within the corresponding cavity 23 by a support element 24 of insulating material. The male contact elements 6 are also provided with press-fit terminals for connection to a printed circuit board. It will be understood that other types of terminals can be used.

Manufacturing of the connectors 1 and 4 is relatively easy. To manufacture the housing 2, a plurality of housing parts 7 is provided, wherein each housing part 7 is metallized completely. The contact elements 3 are overmoulded with support elements 11 and the contact elements 3 with their overmoulded support elements 11 are mounted in the cavities 10 and the housing parts 7 are assembled. Thereafter the front plate 12 is mounted and finally the shielding plate 16.

The connector 4 is manufactured by providing the housing 5 and metallizing the same either the inner walls of the cavities 23 alone or the complete housing. The male contact elements 6 are provided with the support elements 24 by overmoulding. Thereafter the contact elements are mounted in the cavities 23 with their support elements 24.

It will be understood that the connectors described show the advantage that the signal density, i.e. the number of contact elements available as signal elements, is significantly increased. The connectors can be used within existing connector families in an interchangeable manner as the connectors can be manufactured with the same dimensions and same pitch of contact elements as conventional connectors.

The invention is not restricted to the above described embodiments which can be varied within the scope of the claims in a number of ways.

1. Connector for high frequency signals, comprising a housing of insulating material and female contact elements received in said housing and regularly arranged in rows and columns at a fixed intermediate spacing, said housing having a front side with inlet openings providing access to the contact elements, a connection side for connection to a printed circuit board, a cable or the like, and a plurality of cavities extending between the front side and the connection side, adjacent cavities being separated by inner walls extending in row and column direction, each cavity accommodating at least one contact element, characterized in that at least the inner walls of the cavities are metallized, and in that each contact element is supported within the corresponding cavity by support elements of insulating material.

2. Connector according to claim 1, wherein the housing is completely metallized.

3. Connector according to claim 2, comprising a shielding plate enclosing at least partially the housing, said shielding plate being connected to the metallization of the outer walls of the housing.

4. Connector according to anyone of the preceding claims, wherein the housing is an assembly of housing parts of insulating material, each housing part having a first wall extending in column direction and a plurality of second wall sections extending in row direction perpendicular to the first wall, said first wall and said second wall sections providing the inner walls of the cavities, each housing part being completely metallized.

5. Connector according to claim 4, wherein the housing comprises a front wall part of insulating material, said front wall having said inlet openings.

6. Connector according to claim 4 or 5, wherein the first wall of a plurality of said housing parts is provided with second wall sections at both sides thereof, the second wall sections of such a housing part at one side of the first wall being aligned with the corresponding second wall sections at the other side.

7. Connector according to anyone of the preceding claims, wherein the support elements of a contact element are fixed to the contact element

8. Method for manufacturing a connector, comprising the steps of providing a plurality of housing parts, each housing part having a first wall extending in column direction and a plurality of second wall sections extending in row direction perpendicular to the first wall, said first wall and second wall sections providing inner walls of cavities, metallizing each housing part completely, providing a plurality of contact elements with support elements, mounting the contact elements in the cavities by means of the support elements, and assembling the housing parts.

9. Method according to claim 8, wherein the support element is mounted on each contact element by overmoulding.

10. Connector for high frequency signals, comprising a housing of insulating material and male contact elements received in said housing and regularly arranged in rows and columns at a fixed intermediate spacing, said housing having a bottom and two side walls extending in row direction, and a plurality of cavities in the bottom, each cavity accommodating at least one contact element, characterized in that at least the inner walls of the cavities are metallized, and in that each contact element is supported within the corresponding cavity by a support element of insulating material.

11. Method for manufacturing a connector, comprising the steps of providing a housing with a bottom and two side walls, said bottom having a plurality of cavities regularly arranged in rows and columns, metallizing the housing completely including the inner walls of the cavities, providing a plurality of male contact elements with support elements and mounting the contact elements in the cavities by means of the support elements.

12. Method according to claim 11, wherein the support element is mounted on each contact element by overmoulding.
